(19) United States
(12) Patent Application Publication
(10) Pub. No.: US 2001/0027503 A1
(43) Pub. Date: Oct. 4, 2001

(54) Clock generator suitably interfacing with clocks having another frequency

(76) Inventors: Akhiro Yamato, Tokyo (JP); Ryo Yamagata, Tokyo (JP); Kei Yamamoto, Tokyo (JP); Teruaki Shimoda, Tokyo (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/815,875

(22) Filed: Mar. 22, 2001

(30) Foreign Application Priority Data
Mar. 22, 2000 (JP) 2000-080738

(51) Int. Cl. G06F 13/38; G06F 13/40

(52) U.S. Cl. 710/126

(57) ABSTRACT

A reference sync signal for synchronizing with peripheral equipment and an internal clock for an internal operation of a processor system are generated from a reference clock inside the processor system. A base clock is used to generate an internal clock in which a duty of each clock cycle changes. A circuit includes a synchronous counter using a reference sync signal as a reset signal and deciding a count number in accordance with a frequency ratio set in advance, and generates an access timing signal to the peripheral equipment. A conversion circuit synchronously gains access to an external bus operating at a different frequency by using the access timing signal as an enable signal of a latch of an external interface.

### CROSS-REFERENCE TO RELATED APPLICATION

This application is related to U.S. application Ser. No. 09/750,960, filed Dec. 27, 2000, the content of which is incorporated herein by reference.

### BACKGROUND OF THE INVENTION

This invention relates to a clock generator or a clock generation method. More particularly, this invention relates to a clock generator, or a clock generation method, for a processor capable of easily interfacing with peripheral equipment operating in a clock of a relatively lower frequency even when an operation clock of the processor is set to a desired clock frequency.

Higher performance and higher operation speed have been required in the field of information processing systems and controllers and an operation clock frequency of a processor has become higher than ever. On the other hand, peripheral equipment such as a level 2 (L2) cache, a memory controller and a network adaptor are generally operated at a lower frequency than that of the processor for achieving power reduction and due to physical limitations. A drastic improvement in the operation clock frequency has not been made in the peripheral equipment in comparison with the processor. Therefore, even when it is desired to replace a processor mounted with the peripheral equipment to a board by the latest processor having a higher clock frequency, such an attempt has often been given up because synchronization of a clock system (internal clock) on the processor side with a clock system (external clock) on the peripheral equipment side is very difficult.

JP-A-07-210267, for example, inputs one system of clocks from outside and generates a plurality of clock systems without using a phase locked loop (PLL). However, when the method of JP-A-07-210267 is applied to a multi-processor system, for example, a problem of a clock skew develops when synchronization is established among a plurality of clock systems.

Another background art reference, JP-A-05-233275, generates the number of clocks having mutually a fixed phase relationship as the number of clock systems that are required. This JP-A-05-233275 uses a clock having a higher frequency as an operation clock of a processor, and a clock having a lower frequency for a bus input/output signal conversion circuit for exchanging data with an external bus. To mutually synchronize processors having a plurality of clock systems having different frequencies by the use of a PLL, a method shown in FIGS. 14 and 15 of the accompanying drawings is available.

FIGS. 14 and 15 show a circuit for generating and distributing a plurality of kinds of clocks according to the prior art. In these drawings, reference numerals 200, 210 and 240 denote PLL. Numerals 202, 212 and 242 denote phase comparators. Numerals 203, 213 and 243 denote VCO. Numerals 201, 204, 211, 214, 241 and 244 denote frequency dividers. Numerals 205 to 207, 215 to 217, 245 to 247 and 255 to 257 denote buffers (amplifiers).

The example shown in FIG. 14 prepares the same number of independent PLL 200 and 210 as the number of clock systems. In the example shown, each of the two PLLs 200 and 210 receives a reference clock REFCLK for keeping synchronization between the clock systems. The PLL 200 generates an internal clock CLK for use in a processor, and the PLL 210 generates an external clock BUSCLK for use in peripheral equipment. Since the circuit shown in FIG. 14 is equipped with a feedback loop in each of the internal and external clock systems, their phases can be aligned even when mutually different frequencies are further generated from each clock system.

The example shown in FIG. 15 uses only one PLL. In other words, in the example shown in FIG. 15, a single PLL 240 receives the reference clock REFCLK, generates the internal clock CLK to be used in the processor and connects the same number of frequency dividers 244 and 254 as the number of clocks to be derived to an output of a voltage control oscillator (VCO) 243 contained in the PLL. The construction shown in FIG. 15 can avoid mutual interference of PPL that is the problem in the system using a plurality of PLLs.

In the construction using a plurality of PLLs and shown in FIG. 14, each of the clock systems has a feedback line, and skews among the clocks can all be made equal to the internal clock. However, since the chip has a plurality of PLLs, lines of a plurality of clock systems including the clock system for the peripheral equipment extend over the entire chip. Even if the number of flip-flops (F/F) to be driven is smaller such as the clock systems for the L2 cache interface and the external bus interface than those of the overall processor, a scale equivalent to that of the internal clock is necessary. Therefore, the mounting area of the clock systems increases and consumed power increases proportionally. Because mutual interference develops among a plurality of PLLs, design for mounting a plurality of PLLs is extremely difficult.

The construction using a plurality of dividers and shown in FIG. 15 needs only one PLL and can therefore solve the problem of interference among the PLLs. However, because feedback control of the PLLs can be made for only one of the whole clock systems, the remaining clock systems must be phased without the feedback control. Therefore, the circuit design must be made while synchronization of the remaining clock systems is taken into account. In consequence, the remaining clock systems must be equivalent to the internal clock system in the same way as in the construction shown in FIG. 14, and both mounting area and consumed power increase.

### SUMMARY OF THE INVENTION

To solve the problems described above, it may be possible, in principle, to generate internal clocks and external clocks that keep synchronism with one another but have different frequencies, by using logic circuits without extending a plurality of clock systems inside a chip. However, this method is applicable only when a frequency ratio of the internal clock to the external clock (hereinafter called the “internal/external frequency ratio”) is M:1 or M:2 (M: an integer of M>2). Consequently, frequencies of a plurality of clock systems to be constituted are limited. It is therefore desired to develop a method of constituting a system including a plurality of clock systems having an internal/external frequency ratio of M:N (where M and N are integers satisfying the relation M>N>2) by a relatively simple construction using one PLL and logic circuits.

It is an object of the present invention to provide a clock generator, or a clock generation method, capable of generating a plurality of clocks keeping synchronism with one another but having different frequencies by a relatively simple construction.

To accomplish this object, the present invention distributes a reference sync signal REFSYNC to each equipment to which clocks of a plurality of systems are to be distributed, and establishes synchronization. An internal clock of one system that can execute frequency conversion to a clock system using this internal clock is generated from a reference clock REFCLK by using a logic circuit. Therefore, the present invention provides a bus interface controller using the internal clock and an information processing apparatus using them.

Particularly when the internal/external frequency ratio is M:N (where M and N are integers satisfying the relation M>N>2), the object described above can be accomplished by using an internal clock of one system and conducting frequency conversion control and data exchange with a clock system for peripheral equipment having a different frequency by using a logic circuit. Accordingly, the present invention can easily establish synchronization with a plurality of equipment, and can provide a clock generator and a bus interface controller that have a low mounting area and low power consumption and are mountable, and an information processing apparatus using them.

According to one aspect of the present invention, there is provided a clock generator for generating a new clock signal on the basis of a clock signal inputted, comprising: means for generating a plurality of clock signals having different duties from that of the input clock signal; and a selector for selecting one of the plurality of clock signals in each cycle of the clock signal; the clock generator generating a clock signal having the same frequency as that of the input clock but having a different duty cycle in each cycle.

According to another aspect of the present invention, there is provided a bus interface controller in a system in which a processor and peripheral equipment operate at different clock frequencies, comprising: the clock generator described above; means for selecting one pattern capable of bringing a rise or fall of a clock signal having a different duty in each cycle within a predetermined cycle outputted from the clock generator into conformity with a rise of a clock signal of the peripheral equipment, from among a plurality of patterns set in advance in accordance with a mode signal representing a frequency ratio between the processor and the peripheral equipment, and for repeatedly inputting the pattern as a select signal to the selector of the clock generator; and means for exchanging data with the peripheral equipment at a coincident point between the clock signal from the clock generator and the clock signal of the peripheral equipment.

According to still another aspect of the present invention, there is provided an information processing apparatus for operating a processor and peripheral equipment at different clock frequencies, comprising: the bus interface controller described above; a sync signal generation circuit for generating a reference sync signal for allowing the peripheral equipment to synchronize from a reference clock supplied in common to the processor and to the peripheral equipment; an external bus operating at an operation frequency of the peripheral equipment, for connecting the processor to the peripheral equipment; an external bus access timing signal generation circuit for generating a signal representing an access timing to the external bus in accordance with a frequency ratio with the peripheral equipment; and a bus input/output signal conversion circuit for gaining bus access in accordance with the timing signal generated by the external bus access timing signal generation circuit.

The bus interface controller of the present invention having the construction described above includes means for generating a reference sync signal for establishing synchronization among processing apparatuses and operation clocks inside the apparatus from the reference clock. This means further includes means for generating clocks capable of variably setting a duty of each cycle of the internal clock within one period, that period ranges from a synchronization point between the internal and external clocks to their next synchronization point, in accordance with the internal/external operation frequency ratio of the internal clock and the external clock.

The bus interface controller according to the present invention includes a synchronous counter for deciding a count number in accordance with a predetermined frequency ratio by using a reference sync signal as a reset signal, and means for generating an access timing signal to peripheral equipment by comparing the frequency with the synchronous counter. The bus interface controller according to the present invention further includes means for converting the access timing signal to an enable signal of an enabled latch of an external interface and executing frequency conversion control of input/output signals with other processing apparatus by using one system of an internal operation clock through logic circuits alone.

### BRIEF DESCRIPTION OF THE DRAWINGS

FIG. 1 is a block diagram showing a construction of a processor system that constitutes an information processing apparatus according to an embodiment of the present invention;

FIG. 2 is a block diagram showing a construction of an internal clock/sync signal generation circuit 25;

FIGS. 3A and 3B are a circuit diagram useful for explaining the principle of a function of changing a duty cycle of each cycle of a clock signal to be generated, and a timing chart for explaining the operation;

FIG. 4 is a circuit diagram showing a construction for controlling variably and cyclically a duty of each clock cycle within a predetermined period;

FIG. 5 is a diagram useful for explaining a synchronization state of a duty of each cycle of an internal clock and an external clock when a frequency ratio of the internal clock to that of the external clock is 4:3;

FIG. 6 is a diagram useful for explaining a synchronization state between a duty of each cycle of an internal clock and an external clock when a frequency ratio of the internal clock to that of the external clock is 5:4;

FIG. 7 is a block diagram showing a construction of an external bus access timing signal generation circuit 24;

FIG. 8 is a block diagram showing a construction of an external bus output portion of an external bus input/output signal conversion circuit 23 for one bit;

FIG. 9 is a block diagram showing a construction of an external bus input portion of a signal conversion circuit 23 for one bit;

FIG. 10 is a time chart useful for explaining data input/output between a processor core and an external bus when a frequency ratio among an internal clock CLK, an external bus clock BUSCLK and a reference clock REFCLK is 4:3:1;

FIG. 11 is a block diagram showing another structural example of an external bus output portion of a signal conversion circuit 23;

FIG. 12 is a time chart useful for explaining an operation of the circuit shown in FIG. 11;

FIG. 13 is a block diagram showing still another structural example of the external bus output portion of the signal conversion circuit 23;

FIG. 14 is a circuit diagram showing an example of a prior art circuit for generating and distributing a plurality of kinds of clocks; and

FIG. 15 is a circuit diagram showing another example of a prior art circuit for generating and distributing a plurality of kinds of clocks.

### DESCRIPTION OF THE EMBODIMENTS

A clock generator, a bus interface controller and an information processing apparatus using them according to preferred embodiments of the present invention will be explained in detail with reference to the accompanying drawings. To simplify the explanation, however, the embodiments of the invention that follow use clocks of two systems, that is, an internal clock CLK and an external bus clock BUSCLK, although the present invention can generate clocks of three or more systems, too.

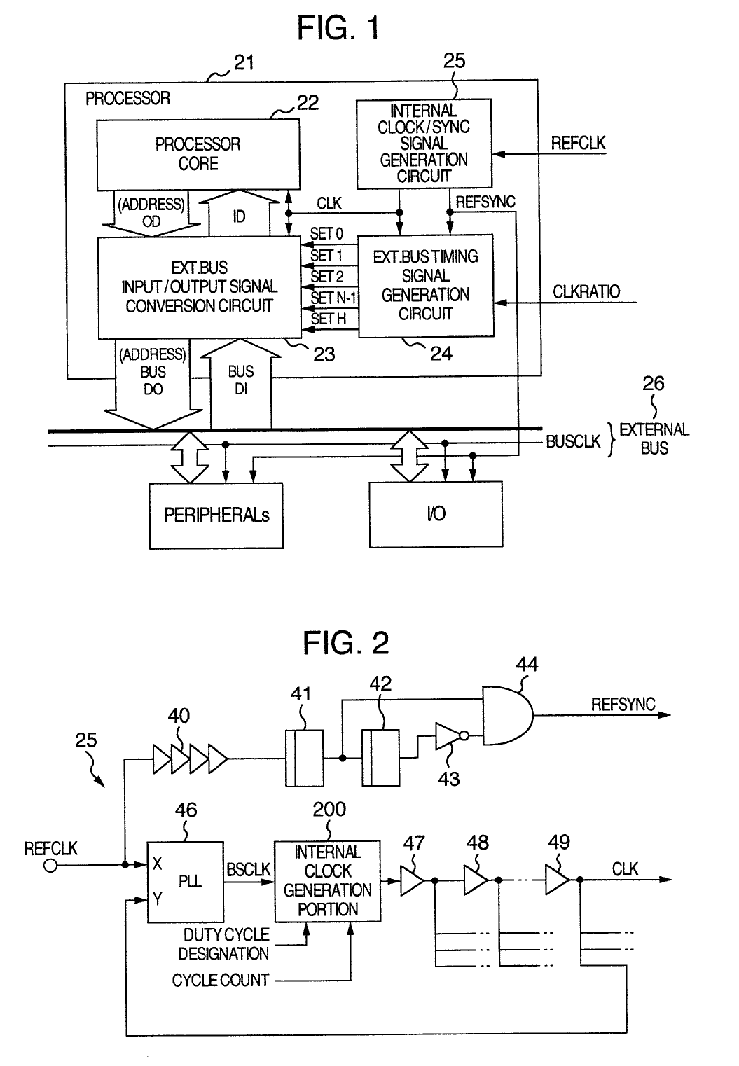

FIG. 1 is a block diagram showing a construction of a processor system that constitutes an information processing apparatus according to an embodiment of the present invention. In the drawing, reference numeral 21 denotes a processor system and numeral 22 does a processor core. Numeral 23 denotes an input/output signal conversion circuit for an external bus and numeral 24 does an external bus access timing signal generation circuit. Numeral 25 denotes an internal clock/sync signal generation circuit and numeral 26 does an external bus. Incidentally, the processor system or the information processing apparatus 21 includes a main storage, an external storage, an input/output device connected through the external bus 26, and so forth.

Referring initially to FIG. 1, the internal clock/sync signal generation circuit 25 generates an internal clock CLK and a reference sync signal REFSYNC from a reference clock REFCLK inputted from outside the processor system 21. The timing signal generation circuit 24 generates an external bus access timing signal from the reference sync signal REFSYNC. The signal conversion circuit 23 converts the address, data and control signals (symbol OD representing an outputting direction and DI representing an inputting direction) of the processor core 22 clocked at the rise of the internal clock CLK and the address, data and control signals (altogether represented by symbol BUSD with BUSDO representing the outputting direction and BUSDI representing the inputting direction) clocked by an external bus clock BUSCLK in accordance with bus access timing signals SET0 to SETN-1 and SETH.

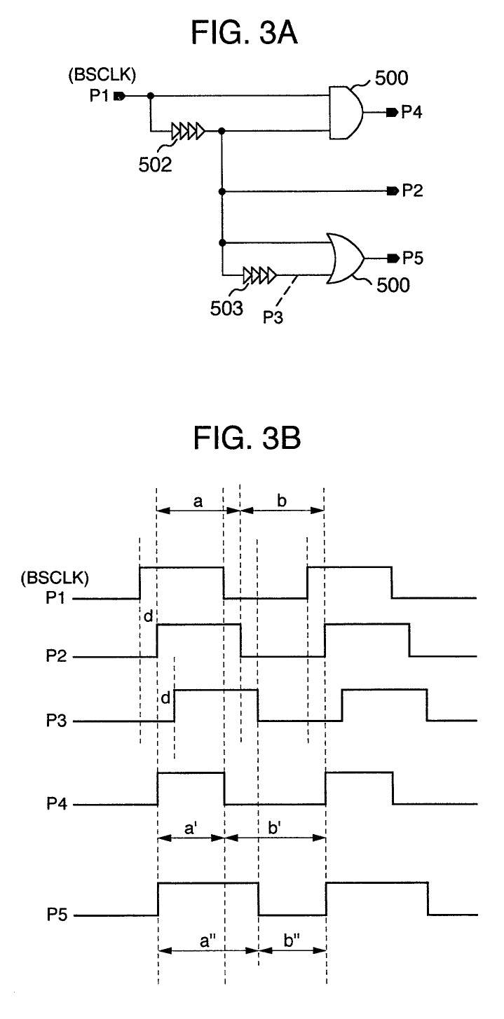

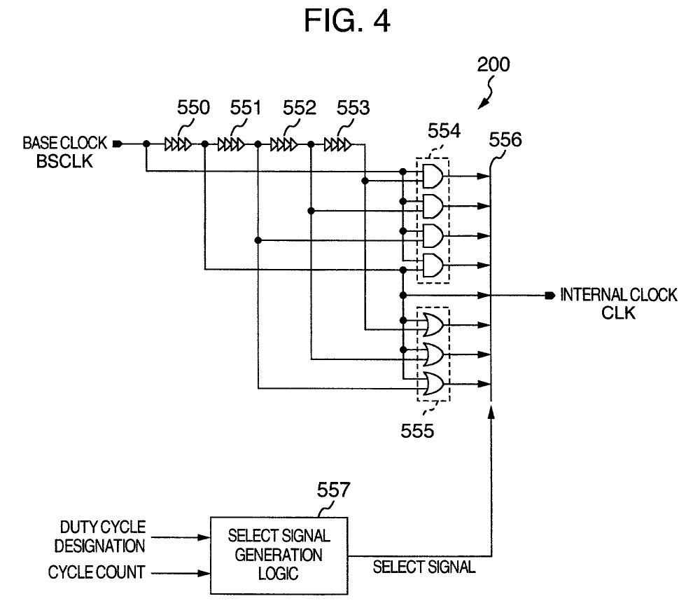

FIG. 2 is a block diagram showing a construction of the sync signal generation circuit 25. FIGS. 3A and 3B are a circuit diagram useful for explaining a function of changing a duty of each cycle of the internal clock signal to be generated, and a timing chart useful for explaining this operation. FIG. 4 is a circuit diagram showing a mechanism for controlling variably and cyclically the duty of each cycle of the internal clock within a predetermined period.

Referring to FIGS. 2 to 4, numerals 40, 502, 503 and 550 to 553 denote delay devices. Numerals 41 and 42 denote latches. Numeral 43 denotes an inverter. Numerals 44 and 500 denote AND devices. Numeral 46 denotes PLL. Numerals 47 to 49 denote buffers. Numeral 501 denotes an OR device. Numeral 554 denotes AND gates. Numeral 555 denotes OR gates. Numeral 556 denotes a selector. Numeral 557 denotes select signal generation logic. Numeral 200 denotes an internal clock generation portion.

The sync signal generation circuit 25 receives the reference clock REFCLK given from outside the processor 21 as its input, generates the internal clock CLK by means of the PLL 46 and also generates the reference sync signal REFSYNC.

The internal clock CLK is fed back to the PLL 46 as shown in FIG. 2. In consequence, the phase of the internal clock CLK is fixed. The internal clock CLK so generated is distributed to the constituents as a whole inside the processor 21. The reference block REFCLK is inputted to the PLL 46 as described above, is delayed by the delay device 40, is then delayed by one cycle by the latch 41 and is further delayed by one cycle by the latch 42. The output signal of the latch 41 and the signal obtained by inverting the output of the latch 42 by the inverter 43 are inputted to the AND device 44 to carry out a logic AND, and are converted to the reference sync signal REFSYNC obtained by differentiating the reference clock REFCLK at the rise, and are outputted. The reference sync signal REFSYNC is the one that is asserted by one cycle within one cycle of the reference clock REFCLK. One cycle of the reference clock REFCLK is the cycle within which the phase of the internal clock CLK coincides with that of the external bus clock BUSCLK. This signal REFSYNC is used for cyclically resetting a synchronous counter of a later-appearing timing signal generation circuit 24. In other words, the reference sync signal REFSYNC is used for phasing the internal clock CLK with the external block BUSCLK.

In the output of the internal clock generation portion 200 in FIG. 2, that is, the internal clock CLK, the duty cycle may be changed in each cycle of its clock signal. The principle of the function of changing this duty cycle will be explained hereinafter with reference to circuit diagrams shown in FIGS. 3A and 3B.

The circuit shown in FIG. 3A includes delay devices 502 and 503, a two-input AND device 500 and a two-input OR device 501. When the clock signal (BSCLK) as the base clock is inputted as a signal P1 in this circuit, a signal P2 is delayed from the base clock signal because of the delay device 502. Assuming that the duty cycle of the base clock signal is 50% (a:b=1:1) and the delay by the delay device 502 is d, an output signal P4 from the two-input AND device 500, to which the signals P1 and P2 are inputted, is a new clock signal (having a duty cycle of less than 50%) having the same frequency as that of the base clock signal but having a different duty cycle (a−d)/(a+b)=a′/(a′+b′).

The signal P2 is further delayed through the delay device 503. Assuming that the delay by this delay device 503 is the same as that of the delay device 502, that is, d, an output signal P5 from the two-input OR device 501, to which the signal P and the signal P2 are inputted, is a new clock signal (having a duty of 50% or more) having the same frequency as the base clock signal but having a different duty cycle, (a+d)/(a+b)=a″/(a″+b″).

When the delay device providing a suitable delay is used in combination with the AND device or the OR device as described above, it becomes possible to obtain a plurality of clock signals having the same frequency and desired duty cycles. It is hereby noted that the rise phases of the output clock signals P2, P4 and P5 are in agreement with one another in FIG. 3A.

The information processing apparatus according to the present invention arbitrarily changes the duty cycle of the internal clock CLK in each cycle and uses this internal clock CLK. Consequently, the information processing apparatus can easily synchronize the external bus access timing of a different clock frequency with the internal clock.

Generally, when the frequency ratio of the internal clock and the external clock is M:N (where M and N are integers and satisfy the relation M>N), the internal clock needs M cycles until the it synchronizes again with the external clock after the internal clock synchronizes once with the external clock. Therefore, the circuit shown in FIG. 3A discriminates the frequency ratio M:N of the internal clock CLK and the external clock BUSCLK by designation of a signal CLKRATIO given from outside. The internal clock CLK is generated within one period (M cycles of the internal clock) in which the former synchronizes with the latter while the duty of each cycle of the internal clock CLK is changed. In this instance, the duty of each cycle of the internal clock CLK is determined beforehand by comparing the relation between the terminal point (latch point) of the cycle of the external clock BUSCLK and the internal clock CLK. More concretely, in the cycle in which the latch point of the external clock BUSCLK does not coincide with the rise of the internal clock CLK, the duty cycle is determined so that the latch point coincides with the fall of the internal clock CLK in this cycle. Incidentally, the cycle at which the latch point of the external clock BUSCLK coincides with the rise of the internal clock CLK may be determined to a predetermined duty.

The circuit shown in FIG. 4 represents an example of the internal clock generation portion 200 that is constituted on the basis of the same concept as that of the circuit explained with reference to FIG. 3. Whereas the circuit shown in FIG. 3 can generate three kinds of clocks having duty cycles of 50%, greater than 50% and smaller than 50%, respectively, on the basis of the input clock (BSCLK) having a duty cycle of 50%, the circuit shown in FIG. 4 selects one of clocks having eight different duties for every cycle of the internal clock and outputs the internal clock CLK.

In other words, the circuit 200 shown in FIG. 4 receives the clock signal having a predetermined frequency (base clock) in a predetermined duty cycle, and inputs the signals generated by delaying step-wise this base clock by the delay devices 550 to 553 with the base clock to AND gates 554 and to the OR gates 555. Consequently, the AND gates 554 and the OR gates 555 provide clocks signals having the same frequency but having different duties, respectively. A duty designation signal (designating which duty is to be selected as a clock signal cycle) and a cycle count signal (not shown) for counting any of the cycles in one period of the internal clock CLK together select any one of these clock signals. A select signal generation logic 557 generates a select signal for selecting the clock signal. A selector 556 controlled by the select signal from this logic 557 selects one of the clock signals in each cycle of the internal clock, and the internal lock is outputted.

Incidentally, the circuit shown in FIG. 4 may use a wired logic and a counter to constitute the select signal generation logic 557. The duty cycle designation signal given from the select signal generation logic 557 and the cycle count signal to a pattern counter inside the logic 557, not shown, may be generated on the basis of the reference clock REFCLK and information CLKRATIO about the ratio of the internal frequency to the external frequency given from outside the system and explained with reference to FIG. 1.

The internal clock generation portion 200 shown in FIG. 4 may be interposed between the PLL 46 of the sync signal generation circuit 25 and the buffer 47 shown in FIG. 2. In consequence, the internal clocks CLK that may have a different duty in each cycle of the reference clock REFCLK can be distributed to the processors 21 as a whole. Incidentally, the feedback line from the buffer 49 to the PLL 46 shown in FIG. 2 restricts the rise phase of the clock. Therefore, no problem develops at all when a circuit for changing the fall timing of the clock and changing the duty is disposed at the position shown in FIG. 2.

Next, the access timing between the processor 21 and the bus that uses the internal clocks CLK having a different duty in each cycle and operates at an external clock having a frequency different from the internal clock CLK will be explained.

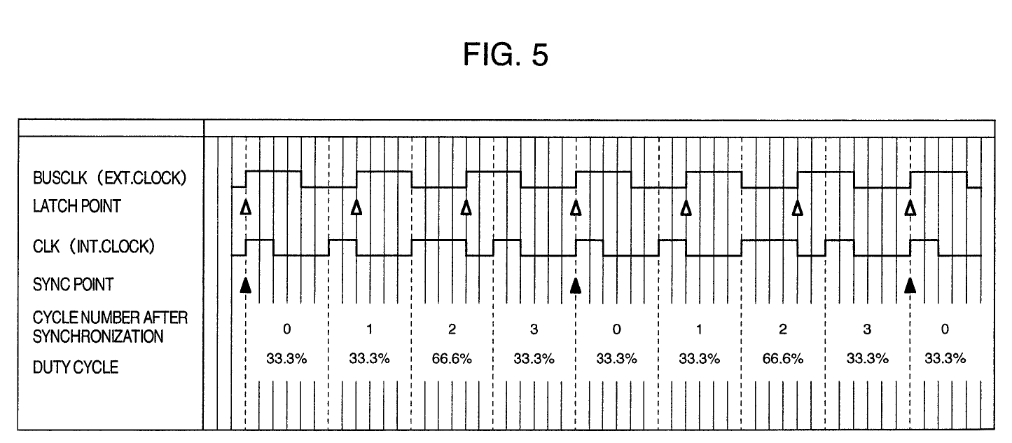

FIG. 5 is a diagram useful for explaining the state of synchronization between the duty of each cycle of the internal clock CLK and the external clock BUSCLK when the frequency ratio is 4:3 between them.

When the frequency ratio is 4:3 between the internal clock CLK and the external clock BUSCLK, the period of the four cycles of the internal clock CLK coincides with the period of the three cycles of the external clock BUSCLK in one period of the reference clock REFCLK. Therefore, the internal clock CLK and the external clock BUSCLK synchronize with each other with the four cycles of the internal clock CLK (or three cycles of the external clock BUSCLK) as one period, and their rise point is coincident. FIG. 5 shows this point as a sync point by black triangles. It will be assumed hereby that the duty cycle of the external clock BUSCLK is 50% and the duty of each cycle of the internal clock CLK is determined so that the rise point of each cycle of the external clock BUSCLK other than the sync point coincides with the fall point of the internal clock CLK.

In this way, it can be appreciated that the duty of each cycle of the internal clock CLK may be selected in the sequence of 33.3% (⅓), 33.3%, 66.6% (⅔) and 33.3%. White triangles represent the points at which the sync point is coincident with the rise point of each cycle of the external clock BUSCLK other than the sync point and the fall point of the internal clock. These white triangles represent the latch points of the external clock BUSCLK. The latch point is used as a data holding timing for exchanging data between the processor system 21 and the external bus 26. Consequently, the data exchange can be executed between a peripheral system and the processor 21 having different frequencies in synchronism with both clocks.

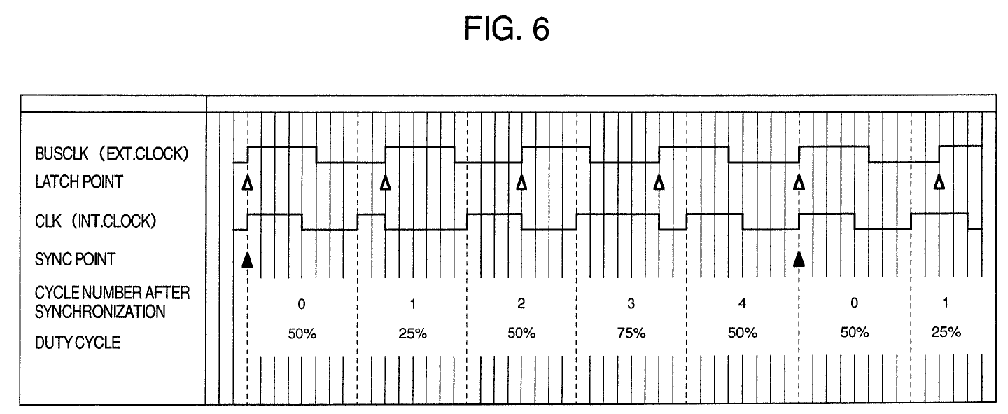

FIG. 6 is a diagram useful for explaining the synchronization state between the duty of each cycle of the internal clock CLK and the external clock BUSCLK when the frequency ratio is 5:4 between them. This diagram has the same meaning as the diagram shown in FIG. 5. In this case, one cycle (represented by black triangle) of the internal clock CLK has five cycles, and each cycle of the internal clock CLK may repeat a pattern having duty cycles of 50%, 25%, 50%, 75% and 50% in this order.

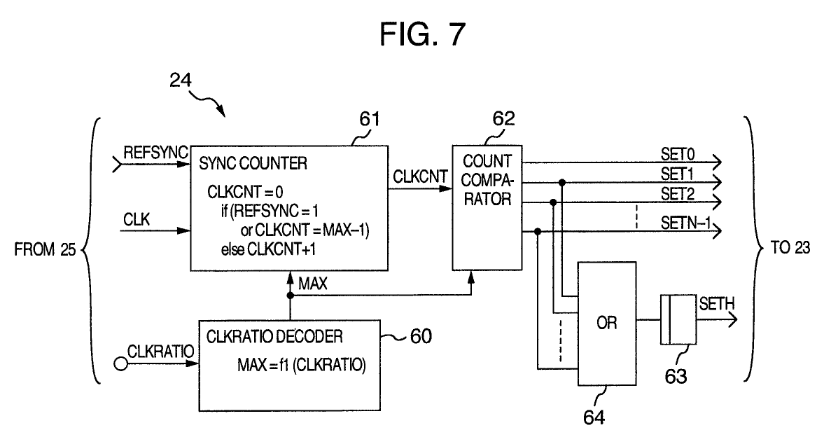

FIG. 7 is a block diagram showing a construction of an access timing signal generation circuit 24 for the external bus. In the drawing, numeral 60 denotes a decoder for decoding CLKRATIO representing a ratio of internal and external frequencies. Numeral 61 denotes a synchronous counter. Numeral 62 denotes a count comparator. Numeral 63 denotes a latch. Numeral 64 denotes an OR device.

The CLKRATIO decoder 60 generates, from information of CLKRATIO inputted from outside the processor 21, a maximum value MAX of the synchronous counter and M in a frequency ratio=M:N of internal and external frequencies (where M>N>2 and M and N are integers), and outputs a decode value that determines at which count value of the synchronous counter 61 each of bus access timing signals SET0 to SETN-1 is to be outputted.

The synchronous counter 61 counts cyclically the clocks CLK from 0 to MAX−1 on the basis of the information from the CLKRATIO decoder 60 and outputs its count value information CLKCNT to the count comparator 62. In this instance, the synchronous counter 61 keeps synchronism by the reference sync signal REFSYNC. The count comparator 62 compares the count value information CLKCNT from the synchronous counter 61 with the decode value from the CLKRATIO decoder 60 and generates the access timing signals SET0, SET1, . . . , SETN-1 for the external bus. The OR devices 64 carries out a logical OR for the access timing signals SET1 to SETN-1 for the external bus other than SET0. The latch 63 delays by one cycle the OR signals and outputs them as the signal SETH.

The signals SET0 to SETN-1 are used as the output enable signals from the signal conversion circuit 23 to the external bus 26. The signals SET0 and SETH are used as the input enable signals from the external bus 26. The signals SET0 to SETN-1 are asserted to designated values that are different in accordance with the given internal/external frequency ratio CLKRATIO, or in accordance with the decode value from the CLKRATIO decoder 60. The designated values may be mounted in advance as a logic circuit to the comparator 62 in such a manner as to cover possible cases.

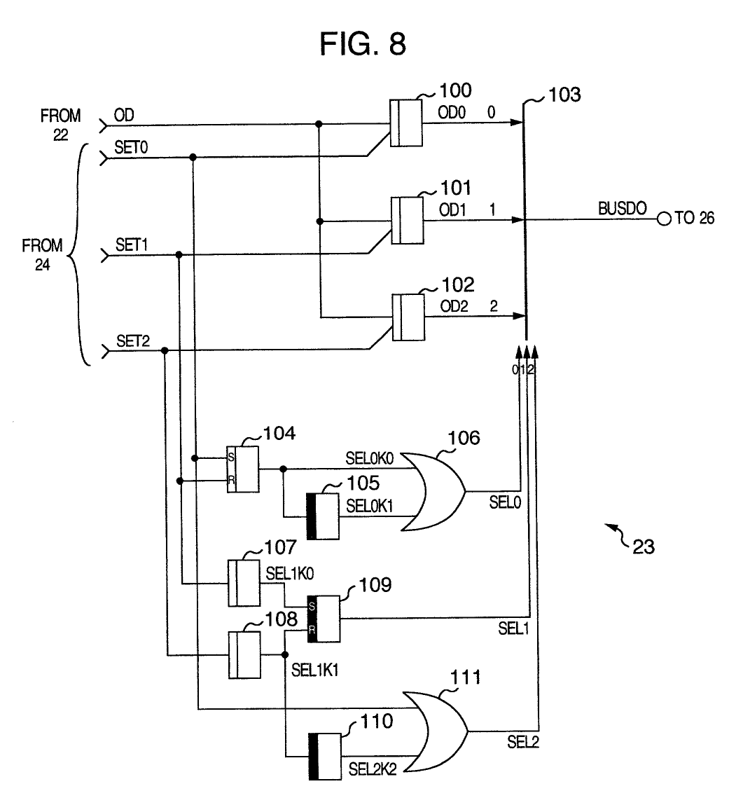

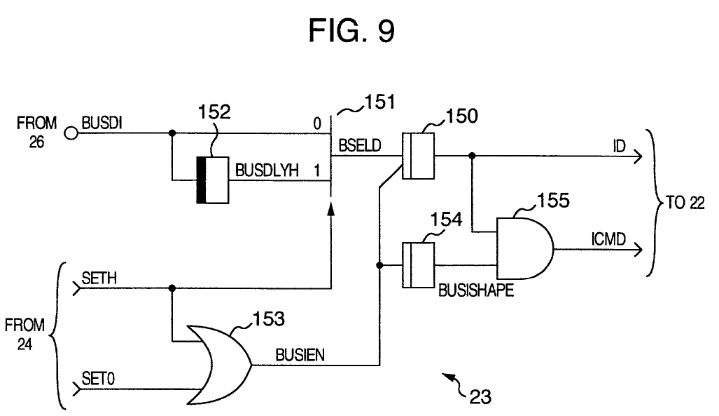

FIGS. 8 and 9 are block diagrams showing per bit a construction of the signal conversion circuit 23 when the ratio of the internal clock frequency to the external block frequency is M:3 (where M is an integer and M>3). In these drawings, numerals 100 to 102, 105, 107, 108, 150, 152 and 154 denote latches. Numerals 103 and 151 denote selectors. Numerals 104 and 109 denote SR latches. Numerals 106, 111 and 153 denote OR devices. Numeral 155 denotes an AND device.

FIG. 8 shows an output circuit portion to the external bus 26. Since the frequency ratio of the internal clock frequency to the external clock frequency is M:3 in this case, the three signals, that is, SET0, SET1 and SET2, are used as the bus access timing signals from the circuit 24 shown in FIG. 7. Referring to FIG. 8, the output signal OD to be outputted to the external bus 26 is the output signal OD0 of the latch 100 generated by converting the signal SET0 to an enable signal, the output signal OD1 of the latch 101 generated by converting SET1 to an enable signal and the output signal OD2 of the latch 103 generated by converting SET2 to an enable signal. After SET0, SET1 and SET2 set the value of the output signal OD, respectively, the three-input selector 103 outputs the output signals in the sequence of OD0, OD1 and OD2 as the output data BUSDO to the external bus 26. Each set signal is combined to generate the select signals SEL0, SEL1 and SEL2 of the selector 103 so that any one of them becomes exclusively ON only during the output period to the bus. Next, generation of each select signal will be explained.

The select signal SEL0 of the output signal OD0 is generated when the OR device 106 carries out the logical OR between SEL0K0 as the output of the SR latch 104 for setting the signal SET0 and resetting SET1 and SEL0K1 as the output of the latch (fall trigger latch) 105 for receiving NOT of the clock CLK as the clock input.

The select signal SELL of OD1 is the output signal of the fall trigger SR latch 109 using the signal SEL1K0 generated by latching SET1 by the latch 107 as its set signal and SEL1K1 generated by latching SET2 by the latch 108 as the reset signal.

The signal SEL2 of OD2 is generated when the OR device 111 carries out the logical OR between the signal SET0 described above and the output signal SEL2K1 obtained by latching SEL1K1 by the fall trigger latch 110.

FIG. 9 shows an input circuit portion from the external bus 26 to the processor core 22. Referring to FIG. 9, the two-input selector 151 selects either the input signal BUSD1 from the bus or BUSDLYH obtained by latching BUSDI by the fall latch 152, in accordance with the value of the select signal SETH, and eventually outputs BSELD.

In the cycle in which the latch point of BUSDI coincides with the fall of the clock CLK, the selector 151 is caused to select BUSDI, and the latch 150 latches this BUSDI. In the cycle in which the latch point of BUSDI does not coincide with the fall of the clock CLK, the selector 151 is caused to execute its selection by directing SETH towards 1 so that the fall latch 152 once latches the value of BUSDI and then the latch 150 latches the value of BUSDLYH at the rise of the next CLK cycle. The enable signal BUSIEN of the latch 150 is the generated when the OR device 153 carries out the logical OR between the signals SETH and SET0 as described above. Incidentally, BSELD is the output signal ID of the latch 150 that converts BUSIEN to an enable signal.

Here, when the AND device 155 carries out the logical AND between ID and the signal BUSISHAPE generated by delaying by one cycle BUSIEN by the latch 154, a signal having a length of one cycle in the internal clock frequency can be cut out and can be used as an input signal ICMD of a control system in the internal circuit.

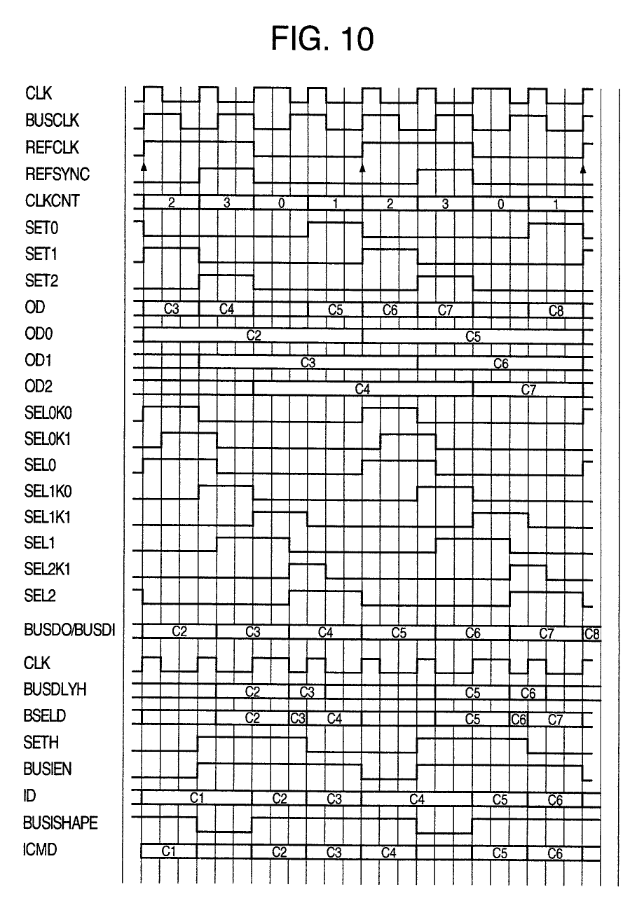

FIG. 10 is a time chart for explaining the data input/output between the processor core and the bus when the frequency ratio of the internal clock CLK, the external bus clock BUSCLK and the reference clock REFCLK is 4:3:1 in the signal conversion circuit 23 explained with reference to FIGS. 8 and 9.

First, the timing chart of the output portion for the external bus shown in FIG. 8 will be explained. SET0, SET1 and SET2 are asserted at the fall when the value of CLKCNT is 1, 2 and 3, respectively. When SET0 is asserted, SEL0K0 is set to 1 in the next CLK cycle. When SET1 is asserted, it is reset to 0 in the next CLK cycle. SEL0K1 becomes the signal that is belated by the ⅓ cycle from SEL0K0. As a result, SEL0 as their OR is 1 only in the 4/3 cycles. In the mean time, the value of the selected OD0 is outputted as BUSD0.

SEL1K0 and SEL1K1 are the signals the cycles of which are belated by one CLK cycle from those of SET1 and SET2, respectively. SEL1K0 is the set signal for the fall trigger SR latch 109 as the select signal SEL1 and SEL1K1 is the reset signal. As shown in FIG. 10, SEL1 remains 1 during the 4/3 cycles from the fall of the CLK cycle of CLKCNT=3, that is, from the ⅓ point from the leading part of the CLK cycle, to the fall of CLKCNT=0, that is, to the ⅔ point from the leading part of the CLK cycle, and the value of selected OD1 is outputted as BUSDO.

SEL2K1 has the value obtained by latching SEL1K1 described above by the fall trigger latch 110. It turns to SEL2 when the logical OR is carried out between SEL2K1 and SET0. SEL2K1 remains 1 for the ⅔ CLK cycle ranging from the latter-half ⅓ point of the CLK cycle of CLKCNT=0 to the former half ⅓ point of CLKCNT=1. SET0 is asserted during the CLK cycle of CLKCNT=1. Therefore, when the logical OR is carried out between SEL2K1 and SET0, SEL1K1 remains 1 during the 4/3 cycles. At the same time, the value of selected OD2 is outputted as BUSDO.

As a result of the operation described above, the value set to OD during the 3 CLK cycles starting from CLKCNT=1 is outputted to the external bus 26 in the 3 BUSCLK cycles from CLKCNT=2 as the starting point.

Next, the timing chart for the external bus input portion shown in FIG. 9 will be explained. Since SET1 and SET2 are asserted at CLKCNT=2 and 3, respectively, SETH selects the bus BUSDLYH when CLKCNT is 3 and 0, respectively. Since SET0 is asserted at the fall of CLKCNT=1, BUSIEN changes to 1 at CLKCNT=3, 0 and 1. The latch 150 sets the value of BUSDLYH at CLKCNT=3 and 0 and the value of BUSDI at CLKCNT=1.

As a result of the operation described above, the signal conversion circuit 23 acquires the continuous data of the 3 cycles on the bus at the point at which BUSCLK synchronizes with CLK (the starting point of the CLKCNT=2 cycle) at CLKCNT=3, 0 and 1, and delivers the output signal ID at CLKCNT=0, 1 and 2 to the processor core 22.

BUSISHAPE generated by latching the set enable signal BUSIEN of the latch 150 by the latch 154 is 1 in the CLK cycle in which effective data is outputted to the signal ID. Therefore, the processor core 22 can directly use the value of BUSISHAPE or the value obtained by conducting the logical AND between ID and BUSISHAPE as the effective data.

The example given above represents the case where the internal/external frequency ratio is 4:3. Next the case where the internal/external frequency ratio is 5:4 will be explained.

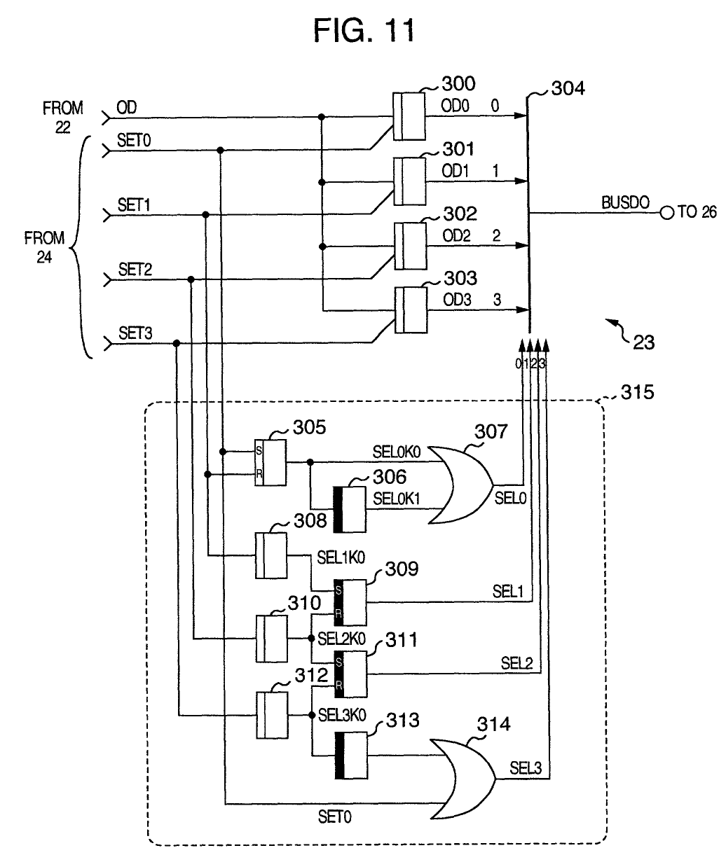

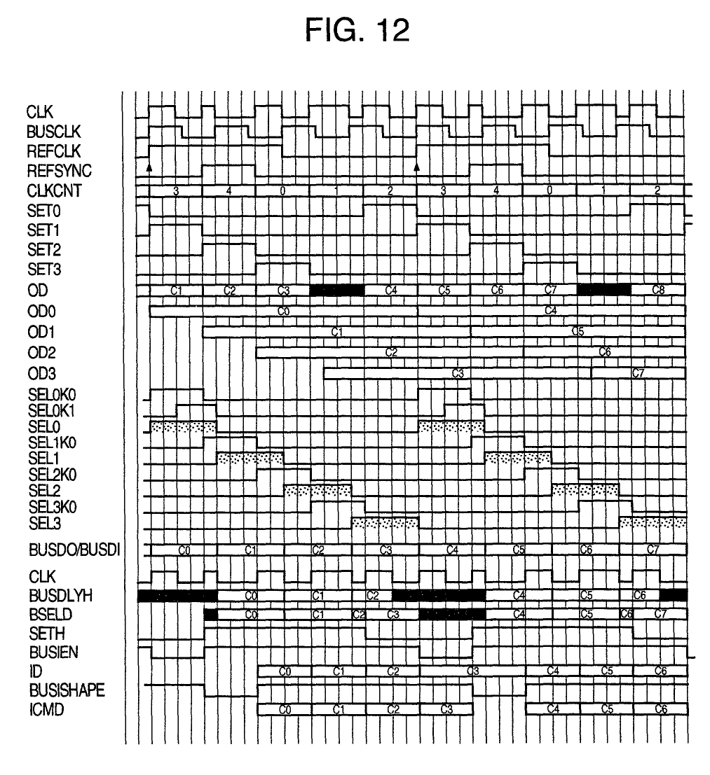

FIG. 11 is a block diagram showing another structural example of the external bus output portion of the signal conversion circuit 23, and FIG. 12 is a time chart useful for explaining its operation. Referring to FIG. 11, numerals 300 to 303, 306, 308, 310, 312 and 313 denote latches. Numeral 304 denotes a selector. Numerals 307 and 314 denote OR devices. Numerals 309 and 311 denote SR latches. The construction of the signal conversion circuit 23 is the same as the construction when the internal/external frequency ratio is 4:3, and is therefore omitted from the drawing.

At the external bus output portion, the access timing signals SET0 to SET3 are asserted when the value of CLKCNT is 2, 3, 4 and 0, respectively. Each select signal from SEL0 to SEL3 becomes serially 1 in the 5/4 CLK cycles with the CLK cycle having the CLKCNT value of 3 as the leading part, and OD0, OD1, OD2 and OD3 are selected in response to the former and are outputted as the bus output data BUSDO.

When the value of CLKCNT is 4, 0 and 1 at the external bus input portion, the value of the bus set to BUSDLYH is set to the latch 150 and is transferred to the internal circuit. When the value of CLKCNT is 2, the value of the bus BUSD1 is set to the latch 150 and is transferred to the internal circuit.

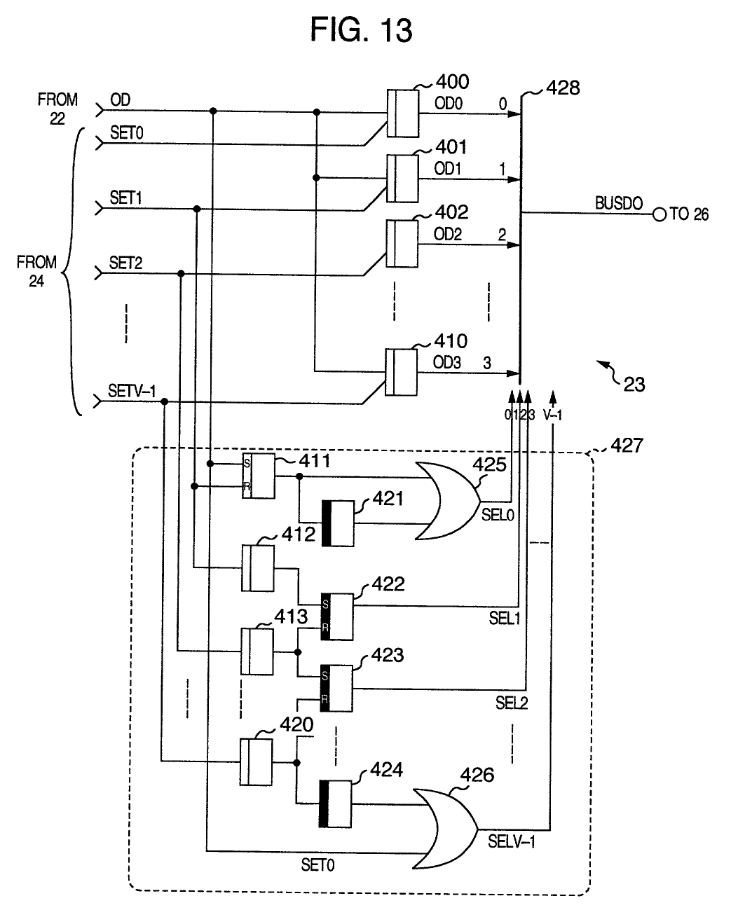

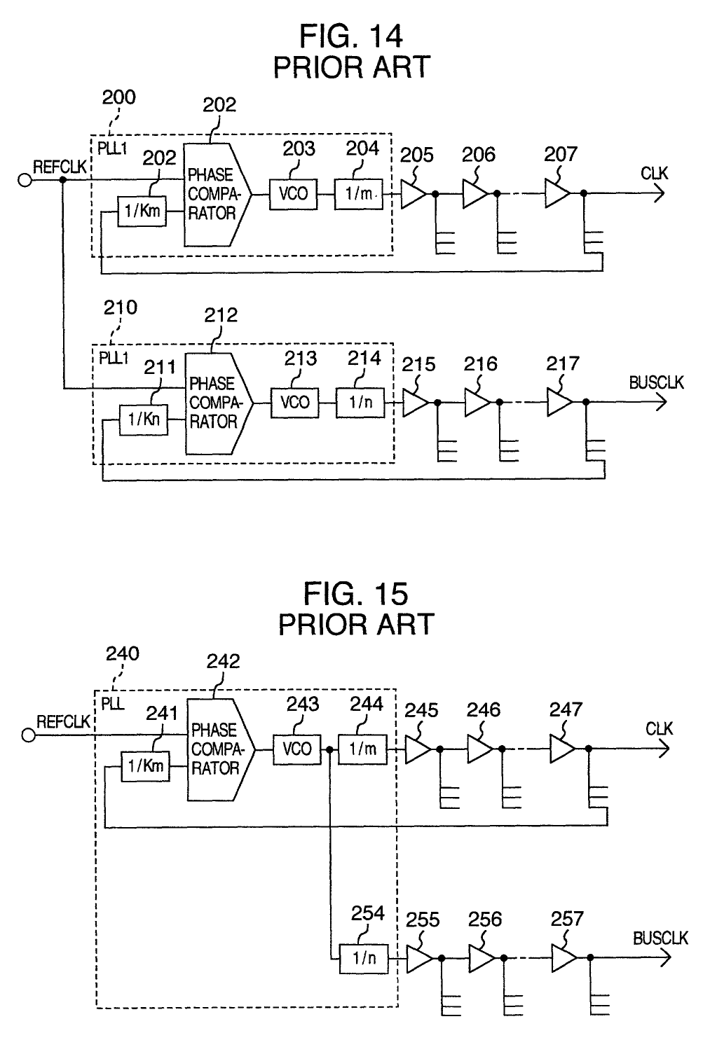

FIG. 13 is a block diagram showing still another construction of the external bus output portion of the signal conversion circuit 23, and represents the case where the internal/external frequency ratio is U:V (U>V>2; each of U and V is an integer). In FIG. 13, numerals 400 to 410, 412 to 420, 421 and 424 denote latches. Numerals 422 and 423 denote SR latches. Numerals 425 and 426 denote OR devices. Numeral 427 denotes a select signal generation portion and numeral 428 denotes a selector.

In this example, only the external bus output portion needs be changed as shown in FIG. 13, and the external bus input portion shown in FIG. 9 may be used as such. The change point of the external bus output portion resides in that the number of output latches ODn to the bus is V, and the select logic in the select signal generation portion 427 increases to (V−N) sets. Those skilled in the art could easily attain such a change.

The embodiments of the present invention described above can provide a clock generator and a bus interface controller each capable of frequency conversion control with a plurality of clock systems by a logic circuit alone using one system of clocks generated from a reference clock so long as an internal clock and an external clock are synchronized with each other by the reference clock or a reference sync signal, and can provide also an information processing apparatus using the clock generator and the bus interface controller.

Therefore, when a frequency ratio of the operating frequency of an internal clock to that of an external interface is M:N (M>N>2; each of M and N is an integer) in a system having an internal circuit and an external interface, the number of clock systems to be distributed to the internal circuit becomes only one, and a mounting area and consumed power can be reduced in comparison with a system for distributing clocks in a plurality of phases.

1. A method of generating an internal clock, for generating M clocks (where M is an integer satisfying the relation M>N>2) within one period of a reference signal having a predetermined frequency in synchronism with an external clock generating N clocks (N is an integer satisfying the relation N>2) within said one period, comprising the steps of:
generating a plurality of clock signals having different duty cycles at a same frequency as that of said internal clock; and
selecting one of said plurality of clock signals in each clock cycle of said internal clock, and generating said internal clock having a clock edge such that a changing direction of said clock edge of said internal clock is coincident with that of said external clock at the start of one period of said reference signal and is opposite to that of said external clock at the start of the clock cycle of said external clock at other times.

2. A method of generating an internal clock according to claim 1, wherein said step of generating said plurality of clock signals carries out a logical AND between a basic clock having the same frequency as that of said internal clock and a delay clock generated by delaying said basic clock by a predetermined time to thereby generate a clock signal as a part of said plurality of clock signals, and carries out a logical OR between said delay clock and other delay clock generated by delaying further said delay clock to generate other clock of said plurality of clock signals.

3. A clock generator for generating M clocks (where M is an integer satisfying the relation M>N>2) within one period of a reference signal having a predetermined frequency in synchronism with an external clock generating N clocks (N is an integer satisfying the relation N>2) within said one period, comprising:
a circuit for generating a plurality of clock signals having different duty cycles at the same frequency as that of said internal clock; and
a circuit for selecting one of said plurality of clock signals in each clock cycle of said internal clock, and generating said internal clock having a clock edge such that a changing direction of said clock edge of said internal clock is coincident with that of said external clock at the start of one period of said reference signal and is opposite to that of said external clock at the start of the clock cycle of said external clock at other times.

4. A clock generator according to claim 3, wherein said circuit for generating said plurality of clock signals further includes:
a logical AND circuit for carrying out a logical AND between a basic clock having the same frequency as that of said internal clock and a delay clock generated by delaying said basic clock by a predetermined time to thereby generate a clock signal as a part of said plurality of clock signals; and
a logical OR circuit for carrying out a logical OR between said delay clock and other delay clock generated by delaying further said delay clock to generate other clock of said plurality of clock signals.

5. A method of generating an input/output timing in a processor operating by an internal clock generating M clocks (where M is an integer satisfying the relation M>N>2) within one period of a reference signal having a predetermined frequency in synchronism with an external clock generating N clocks (N is an integer satisfying the relation N>2) within said one period, comprising the steps of:
generating a plurality of clock signals having different duty cycles at the same frequency as that of said internal clock;
selecting one of said plurality of clock signals in each clock cycle of said internal clock, and generating said internal clock having a clock edge such that a changing direction of said clock edge of said internal clock is coincident with that of said external clock at the start of one period of said reference signal and is opposite to that of said external clock at the start of the clock cycle of said external clock at other times;
generating a plurality of set signals asserting each clock cycle of said internal clock;
generating second set signals asserting the clock cycle of said internal clock at times other than the start of said reference signal; and
inputting data from said external bus by utilizing the edges of said plurality of set signals and said second set signal, and determining a timing for outputting the data to said external bus.

6. A processor operating by an internal clock generating M clocks (where M is an integer satisfying the relation M>N>2) within one period of a reference signal having a predetermined frequency in synchronism with an external clock generating N clocks (N is an integer satisfying the relation N>2) within said one period, comprising:
a circuit for generating a plurality of clock signals having different duty cycles at the same frequency as that of said internal clock;
a circuit for selecting one of said plurality of clock signals in each clock cycle of said internal clock, and generating said internal clock having a clock edge such that a changing direction of said clock edge of said internal clock is coincident with that of said external clock at the start of one period of said reference signal and is opposite to that of said external clock at the start of the clock cycle of said external clock at other times;
a circuit for generating a plurality of set signals asserting each clock cycle of said internal clock;
a circuit for generating second set signals asserting the clock cycle of said internal clock at times other than the start of said reference signal; and
an input/output signal conversion circuit for inputting data from said external bus by utilizing the edges of said plurality of set signals and said second set signal, and determining a timing for outputting the data to said external bus.

7. A clock generator for generating a new clock signal on the basis of a clock signal inputted, comprising:
means for generating a plurality of clock signals having the same frequency as that of the input clock signal but having different duty cycles; and
a selector for selecting one of said plurality of clock signals in each cycle of said clock signal;
said clock generator generating a clock signal having the same frequency as that of said input clock but having a different duty cycle in each cycle.

8. A bus interface controller in a system in which a processor and peripheral equipment operate at different clock frequencies, comprising:
said clock generator according to claim 7;
means for selecting one pattern capable of bringing a rise or fall of a clock signal having a different duty in each cycle within a predetermined period outputted from said clock generator into conformity with a rise of a clock signal of said peripheral equipment, from among a plurality of patterns set in advance in accordance with a mode signal representing a frequency ratio between said processor and said peripheral equipment, and for repeatedly inputting said pattern as a select signal to said selector of said clock generator; and
means for exchanging data with said peripheral equipment at a coincident point between said clock signal from said clock generator and said clock signal of said peripheral equipment.

9. An information processing apparatus for operating a processor and peripheral equipment at different clock frequencies, comprising:
said bus interface controller according to claim 8;
a sync signal generation circuit for generating a reference sync signal for allowing said peripheral equipment to synchronize from a reference clock supplied in common to said processor and to said peripheral equipment;
an external bus operating at an operation frequency of said peripheral equipment, for connecting said processor to said peripheral equipment;
an external bus access timing signal generation circuit for generating a signal representing an access timing to said external bus in accordance with a frequency ratio with said peripheral equipment; and
a bus input/output signal conversion circuit for gaining bus access in accordance with the timing signal generated by said external bus access timing signal generation circuit.
